(19) United States
(12) Patent Application Publication
(10) Pub. No.: US 2016/0163200 A1
(43) Pub. Date: Jun. 9, 2016

(54) MANAGING AND CONTROLLING TRAVEL FOR A CONVOY OF VEHICLES

(71) Applicant: eBay Enterprise, Inc., King of Prussia, PA (US)

(72) Inventors: Robert He, Pflugerville, TX (US); Bryant Luk, Round Rock, TX (US); Christopher Diebold O'Toole, Cedar Park, TX (US); Jennifer Brenner, Austin, TX (US); Yu Tang, Round Rock, TX (US); Ananya Das, Austin, TX (US); Jason Ziaja, Cedar Park, TX (US)

(21) Appl. No.: 14/559,849

(22) Filed: Dec. 3, 2014

(51) Int. Cl. G08G 1/00

(52) U.S. Cl. CPC G08G 1/22

(57) ABSTRACT

Disclosed are systems, mediums, and methods for managing and controlling travel for a convoy of vehicles. A traffic control system includes a traffic control device that receives one or more signals indicating two or more vehicles proximate to a location. The traffic control device determines a convoy based at least on the one or more signals, where the convoy includes the two or more vehicles proximate to the location. The traffic control device determines traffic-signal data based at least on the convoy, where the traffic-signal data is configured to maintain threshold distances between two or more vehicles in the convoy. The traffic control device transmits the traffic-signal data to a traffic controller configured to select one or more traffic signals, where the one or more traffic signals enable the two or more vehicles to maintain the threshold distances between the two or more vehicles in the convoy.

### TECHNICAL FIELD

This disclosure generally relates to vehicle traffic, and more particularly, to devices providing data to traffic controllers and/or vehicles.

### BACKGROUND

Various types of systems may analyze traffic conditions of roads and/or highways. Such systems may include motorway networks, closed-circuit televisions, global positioning systems (GPS) and/or other types of technology that may monitor vehicles and traffic conditions. In some instances, systems may employ multiple cameras to monitor the traffic conditions. Various types of cameras may include traffic cameras, toll cameras, speed cameras, and/or other cameras configured to send and/or receive data associated with the traffic conditions in one or more geographic areas.

In addition, various types of systems may manage traffic flows. For example, ramp metering systems may reduce the volume of traffic entering a motorway. Further, queue protection systems may vary speed limits on the motorway. In particular, the varying speed limits may be displayed on overhead lane control signs (LCS) to inform drivers accordingly, thereby reducing traffic congestion. In some instances, systems may coordinate traffic using time-based methods to optimize traffic flows. Yet, despite the advancements in modern systems, traffic problems are becoming increasingly more common, demonstrating the demand for systems and/or devices that can monitor and manage traffic conditions more intelligently and effectively.

### BRIEF DESCRIPTION OF THE DRAWINGS

FIG. 1 is a simplified block diagram of an traffic control system, according to an embodiment;

FIG. 2 illustrates an exemplary traffic control system, according to an embodiment.

FIG. 3 illustrates a traffic control device, according to an embodiment;

FIG. 4 illustrates a client device, according to an embodiment;

FIG. 5 is a flowchart of an exemplary method, according to an embodiment;

FIG. 6A illustrates a client device, according to an embodiment; and

FIG. 6B illustrates a client device, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for any limiting purposes.

### DETAILED DESCRIPTION

Traffic problems continue to cause problems for many drivers. For example, some drivers may run into traffic jams when simply commuting from an origin to a nearby destination just a few miles away. In various instances, these problems may involve challenges related to the traffic systems that manage traffic conditions. For example, various systems may utilize camera devices, vehicle counting devices, weight sensors, inductive loop sensors, and/or other types of sensors and/or devices configured to detect vehicles. In various circumstances, the efforts to improve these systems on roads and/or highways may be expensive and time consuming.

Yet, portable devices such as mobile phones, personal computers, laptop computers, tablet computers, and countless types of Internet-capable devices are increasingly more prevalent in numerous aspects of modern life. For example, many portable devices may be configured to send and/or receive various types of signals such as cellular signals, Bluetooth signals, Wi-Fi signals, radio frequency (RF) signals, and/or other signals detectable over the air interface. Further, many vehicles may also be configured to send and/or receive such signals. In various embodiments, these portable devices and/or vehicles may facilitate real-time traffic monitoring and management. For example, by positioning sensors near roads, highways, traffic signs, and/or traffic lights, various signals from the portable devices and/or vehicles may be detected and tracked. In particular, the portable devices and/or the vehicles may be tracked, enabling traffic control systems to accurately obtain data related to the passing vehicles. As such, various types of data received may be used to improve traffic conditions and mitigate risks associated with accidents.

In some embodiments, a system may include a traffic control device, such as one mounted on or near a traffic light. Further, the traffic control device may receive signals from portable devices in passing vehicles and/or vehicles with signal transmitting capabilities. In some instances, the traffic control device may determine a convoy of vehicles approaching the traffic control device. For example, the convoy of vehicles may include approximately two to twenty vehicles, or more, approaching the traffic control device. As such, the traffic control device may control the traffic light accordingly, possibly timing the traffic light to turn green as the convoy approaches the traffic light. Further, the traffic control device may maintain the green light to keep the vehicles together in the convoy as the vehicles pass through the traffic light. Further, in some instances with a larger convoy, the traffic control device may control the traffic light to turn red sooner to maintain the vehicles in the convoy without impacting traffic flows in other directions. Yet further, the traffic control device may control additional traffic lights ahead of the convoy based on an estimated path and/or direction of the convoy. As such, the additional traffic lights may allow the convoy to pass through additional intersections without slowing down and/or stopping traffic. The additional traffic lights may maintain the vehicles in the convoy, optimizing traffic flows accordingly and reducing the probability of vehicle collisions.

In some embodiments, users within vehicles in a convoy may be notified and/or instructed to speed up or slow down. In some instances, such notifications and/or instructions may be based on various data and/or factors, such as keeping the vehicles together in the convoy through intersections and reducing various risks of accidents. For example, if an upcoming traffic light is about to turn red, the first vehicle and/or other vehicles in the convoy may be notified and/or instructed to slow down. If one or more vehicles in the convoy are slower, e.g., creating too much separation from the first vehicle(s), those slower vehicles may be notified to speed up to catch up to the first vehicle(s). In some instances, the notified vehicles may speed up and maintain respective speeds, e.g., rates of travel, through the traffic light such that the notified vehicles make it through a green light in the convoy. In some instances, the green light may turn yellow after a given period of time such that slower vehicles are forced to exit the convoy.

In some embodiments, a request to create a convoy may be made to a traffic control system. In some instances, a driver may wish to create a convoy for multiple vehicles. For example, the driver may wish to create the convoy particularly for a road trip planned for multiple vehicles to reach a vacation destination several miles away. As such, the driver may create a request for the convoy and the request may be sent to a traffic control system that manages multiple convoys. In some instances, the traffic control system may grant the request and create a convoy for the vehicles to reach the destination. As such, the convoy of vehicles may stay together and reach the vacation destination with little or no traffic congestion. In some instances, the convoy may reach the destination in less time than it would take the vehicles to reach the destination without creating the convoy. Further, in some instances, the system may recommend the drivers to join an existing convoy also headed towards the same destination. Yet further, in some instances, the system may send a request to the drivers to allow other vehicles to join or enter their convoy.

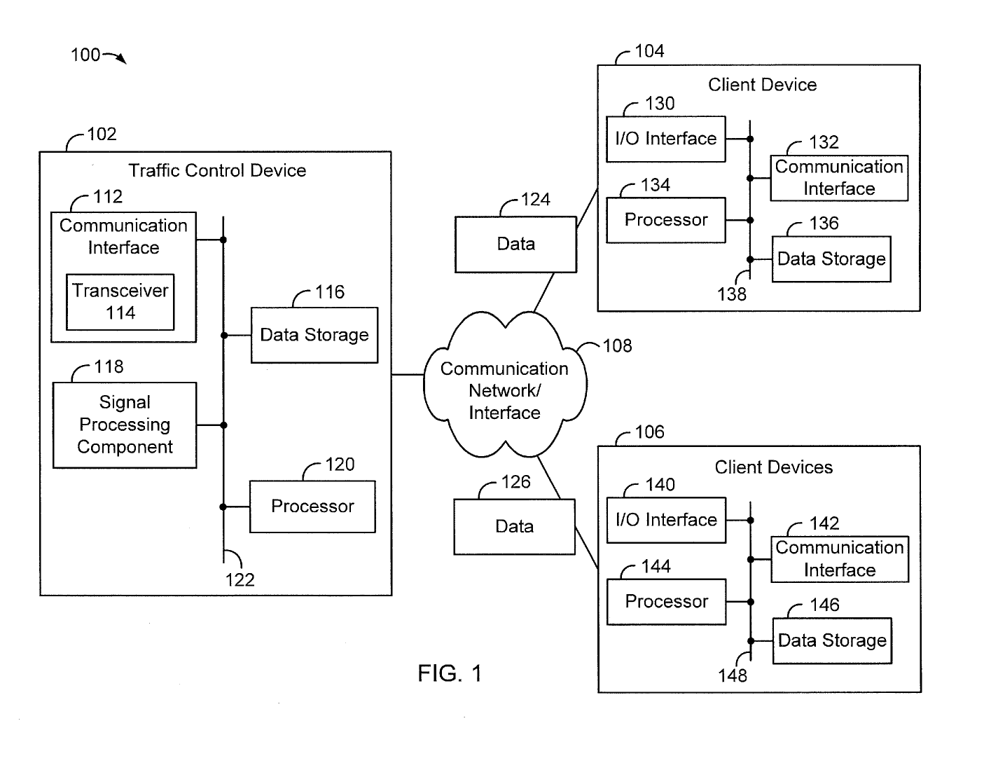

FIG. 1 is a simplified block diagram of an example traffic control system 100, according to an embodiment. As shown, the traffic control system 100 includes multiple computing devices such as a traffic control device 102, a client device 104, and a client device 106. In some instances, the traffic control device 102 may be configured to receive data 124 and 126 from the client devices 104 and 106, respectively. For example, the traffic control device 102 may receive the data 124 and 126 in the form of signals and/or data signals including data. Further, the traffic control device 102, the client device 104, and the client device 106 may be configured to communicate with each other through the communication network/interface 108. In some instances, the traffic control system 100 may operate with more or less computing devices than those shown in FIG. 1.

The communication network/interface 108 may include a wireless interface such as a wide-area wireless interface, a cellular network interface, a multi-range radio frequency interface, an IEEE 802.11 interface, a Wi-Fi interface, a wireless interface over a 2.4 GHz bandwidth, a BLUETOOTH® interface, a Wireless USB interface, and/or other types of interfaces configured to enable transmitting and receiving data between devices. Further, the communication network/interface 108 may include a data network, a closed-circuit network, a switch network, and/or a packet-switched network, among other networks configured to provide communications and exchange data of various forms, content, type, and data structures. For example, the communication network/interface 108 may exchange data 124 and 126 between the traffic control device 102, the client device 104, and the client device 106 through small scale communication networks, such as a private or local area network, or a larger scale network, such as a wide area network or the Internet, possibly accessible by the various components of system 100. Communication network/interface 108 may also include network adapters, switches, routers, network nodes, and various buffers and queues to exchange various forms of data. For example, communication network/interface 108 may be configured to exchange data 124 and/or 126 through various protocols such as Transmission Control Protocol/Internet Protocol (TCP/IP), among other possibilities.

The traffic control system 100 may also include other computing devices or implement software components that perform various implementations in accordance with this disclosure and illustrated by the accompanying figures. For example, the traffic control system 100 may include other client devices, stand-alone and/or enterprise-class servers possibly implementing MICROSOFT®, UNIX®, LINUX®, and other client-based and/or server-based operating systems, among other types of operating systems. It can be appreciated that traffic control devices and client devices illustrated in FIG. 1 may be deployed in other ways. The operations performed and the services provided by such devices may be combined or separated for a given embodiment. Further, such operations and services may be performed by a greater number or a fewer number of devices and/or server devices. Yet further, one or more of the devices may be operated and maintained by the same or different entities.

The traffic control device 102 may be configured to perform a variety of functions, such as those described in this disclosure and illustrated by the accompanying figures. For example, the traffic control device 102 may be configured to receive, transmit, and/or access signals, data signals, and/or data, e.g., data 124 and 126, possibly indicating one or more vehicles proximate to a location. Further, the traffic control device 102 may receive data 124 and/or 126 from one or more vehicles. In some instances, the traffic control device 102 may store data 124 and/or 126 in data storage 116. Further, the control device 102 may access the data 124 and/or 126 from the data storage 116 based on the one or more signals received. In some instances, the one or more signals may be received over the communication network/interface 108. For example, signals may be received over various wireless interfaces as described above. Further, the signals may be received from network nodes, network adapters, switches, routers, and/or various buffers and queues of the communication network/interface 108. Yet further, traffic control device 102 may receive the data 124 and/or 126 from the client devices 104 and/or 106, respectively.

The traffic control device 102 may take a variety of forms and may include various components, including, for example, a communication interface 112, a transceiver 114, data storage 116, a signal processing component 118, and a processor 120, any of which may be communicatively linked to the other components via a system bus, network, or other connection mechanism 122. As shown, the transceiver 114 may be incorporated with and/or embedded within the communication interface 112. In some instances, the signal processing component 118 may be incorporated with and/or embedded within the processor 120.

The communication interface 112 may take a variety of forms and may be configured to allow the traffic control device 102 to communicate with one or more devices. For instance, communication interface 112 may be configured to enable communication with traffic control device 102 and client devices 104 and/or 106 via communication interface 108. In one example, communication interface 112 may include a wide-area wireless interface, a cellular network interface, a multi-range radio frequency interface, an IEEE 802.11 interface, a Wi-Fi interface, a wireless interface over a 2.4 GHz bandwidth, a BLUETOOTH® interface, a Wireless USB interface, and/or other types of interfaces configured to transmit and receive data 124 and/or 126. Yet further, communication interface 112 may include a wired interface, such as an Ethernet interface and/or a Local Areas Network (LAN) network interface.

In some instances, the communication interface 112 may receive, transmit, and/or access signals, data signals, and/or data, e.g., data 124 and/or 126. In some instances, the signals, data signals, and/or data may indicate one or more vehicles, possibly proximate to a location. For example, the communication interface 112 may receive one or more signals from one or more vehicles proximate to a location. Yet further, the communication interface 112 may receive one or more signals from one vehicle, possibly a vehicle from the one or more vehicles proximate to the location. In addition, the traffic control device 102 may access data based at least on one or more signals received by communication interface 102. In some instances, the traffic control device 102 may access the data 124 and/or 126 from network nodes, network adapters, switches, routers, and/or various buffers and queues of the communication network/interface 108. Yet further, the traffic control device 102 may transmit, receive, and/or access the data packets from the client devices, among other possibilities to exchange the data packets. As noted, the communication interface 112 may include a transceiver 114. Further, the transceiver 114 may receive, transmit, and/or access the signal, data signals, and/or the data, e.g., data 124 and/or 126, described above in relation to the communication interface 112.

The processor 120 may include and/or take the form of a general purpose processor, e.g., a central processing unit (CPU), a microprocessor, a baseband processor, an applications processor, a controller, a programmable system on chip, and/or another type of processing component. Further, the processor 120 may include and/or take the form of a special purpose processor such as a digital signal processor (DSP), a graphics processing unit (GPU), a floating point unit (FPU), a network processor, and/or an application-specific integrated circuits (ASIC). As such, the processor 120 may transmit/receive the data 124 and 126, possibly to/from the client device 104 and the client device 106, respectively. For example, the data 126 and 128 may be transmitted over communication network/interface 108. Further, the data 126 and 128 may include IP addresses of client device 104 and 106, respectively. Yet further, the data 126 and 128 may also include protocol data such as Transmission Control Protocol/Internet Protocol (TCP/IP). In various embodiments, the data 126 and 128 may include 1,000 to 1,500 bytes, among other possible data capacity ranges.

The data storage 116 may include one or more volatile, non-volatile, removable, and/or non-removable storage components, such as magnetic, optical, or flash storage, and may be integrated in whole or in part with processor 120. Further, the data storage 116 may include and/or take the form of a non-transitory computer-readable storage medium, having stored thereon machine-readable instructions, e.g., compiled or non-compiled program logic and/or machine code. In some instances, the instructions may be executed by the processor 116 and/or the signal processing component 118 of traffic control device 102. Further, the instructions may cause the traffic control device 102 to perform operations, such as those described in this disclosure and illustrated by the accompanying figures.

The signal processing component 118 may include and/or take the form of a special purpose processor for processing signals received from one or more devices. For example, the signal processing component 118 may include and/or take the form of a digital signal processor (DSP), a graphics processing unit (GPU), a floating point unit (FPU), a network processor, and/or an application-specific integrated circuit (ASIC). Further, the signal processing component 118 may include and/or take the form of a general purpose processor, a central processing unit (CPU), a microprocessor, a baseband processor, an application processor, a controller, a programmable system on chip, and/or another type of processing component.

The signal processing component 118 and/or the processor 120 may determine one or more vehicles based on one or more signals. In some instances, the signals may include data signals and/or data identifying the one or more vehicles. For example, the signals may include cellular signals, Bluetooth signals, Wi-Fi signals, and/or other signals described above that identify the one or more vehicles. In some instances, the signals may include and/or indicate vehicle identification numbers (VIN), license plate numbers, driver license numbers of drivers of the one or more vehicles, and/or other types of numbers and/or codes. As such, the signals may identify the one or more vehicles and/or a number of the one or more vehicles. In some instances, the signals may include data signals and/or data identifying one or more locations of the one or more vehicles. For example, the signals may include base station signals, cellular data, GPS signals, GPS data, and/or other types of signals and/or data indicating the locations of one or more of the vehicles.

In some embodiments, the signal processing component 118 and/or the processor 120 may also determine a convoy of one or more vehicles. In some instances, the convoy may include one or more of the vehicles identified by the signals received. Further, the convoy may include one or more of the vehicles proximate to a location, possibly indicated by the signals received. In some instances, the convoy may be determined by signals, data signals, and/or data described above. In some instances, the signals may indicate the number of vehicles in the convoy and/or various types of numbers and/or codes described above that may identify the one or more vehicles.

In some embodiments, the signal processing component 118 and/or the processor 120 may determine traffic-signal data based on the convoy. In some instances, the traffic-signal data may be configured to maintain a threshold distance between two or more of the vehicles. Further, the traffic-signal data may be configured to maintain a threshold distance between the first vehicle and the last vehicle of the convoy. Yet further, data may be configured to maintain the one or more vehicles in the convoy. For example, the data may be configured to keep one or more of the vehicles within a range of a vehicle located in the center of the convoy, among other possibilities.

The signal processing component 118 may include pre-configured circuits, dedicated circuits, and/or hardware components of the traffic control device 102. Further, the signal processing component 118 may include circuits and/or hardware components that are configured to carry out one or more operations described in this disclosure and illustrated by the accompanying figures. For example, the signal processing component 118 may determine one or more vehicles from the data 126 and/or 128. Yet further, signal processing component 118 may also determine a convoy of the one or more vehicles from the data 126 and/or 128.

In some embodiments, a communication interface 112 of the traffic control device 102 may receive one or more signals, e.g., data signals and/or data 124 and 126, indicating one or more vehicles proximate to a location. Further, the signal processing component 118 of the traffic control device 102 may determine a convoy based at least on the one or more signals, where the convoy includes one or more vehicles proximate to the location. Yet further, a data processing component, e.g., the processor 120, of the traffic control device 102 may determine traffic-signal data based at least on the convoy, where the traffic-signal data is configured to maintain a threshold distance between two or more of the vehicles in the convoy. In addition, the transceiver 114 of the communication interface 112 may transmit the traffic-signal data to the client device 106, e.g., a traffic controller, configured to select one or more traffic signals. Further, the one or more traffic signals may enable the one or more vehicles to maintain the threshold distance between two or more of the vehicles in the convoy.

Client devices 104 and 106 may be configured to perform a variety of operations such as those described in this disclosure and illustrated by the accompanying figures. For example, client devices 104 and 106 may be configured to transmit/receive signals to/from the traffic control device 102 such as data signals and/or the data 126 and 128. The client devices 104 and 106 may take a variety of forms such as a personal computer (PC), a smart phone, a laptop/tablet computer, a wearable computing device, a smart watch, and/or a head-mountable display, among other types of computing devices capable of transmitting and/or receiving data. Further, client devices 104 and 106 may take the form of an unmanned aerial vehicle (UAV), a drone device, a robotic device, a device capable of taking flight, and/or other types of portable devices capable of sending and/or receiving signals, data signals, and/or data. The client devices 104 and 106 may include various components, including, for example, I/O interfaces 130 and 140, communication interfaces 132 and 142, processors 134 and 144, and data storages 136 and 146, respectively, all of which may be communicatively linked with each other via a system bus, network, or other connection mechanisms 138 and 148, respectively.

The I/O interfaces 130 and 140 may be configured for facilitating interaction between client devices 104 and 106 and users of client devices 104 and 106, possibly to communicate with the traffic control device 102. For example, I/O interfaces 130 and 140 may be configured to produce and/or generate audio instructions sent by the traffic control device 102, possibly to maintain one or more vehicles in a convoy. As such, I/O interfaces 130 and 140 may include a sound/audio speaker, an audio output mechanism, and/or a haptic feedback system. Further, the instructions may be rendered and/or displayed via one or more displays of the I/O interfaces 130 and 140. As such, I/O interfaces 130 and 140 may include output components such as displays, display screens, touch sensitive panels, windshield displays, augmented reality displays, and/or other types of output devices to display the instructions. Further, I/O interfaces 130 and 140 may include input components such as a camera, a camera configured to capture audiovisual data, a microphone configured to capture sound data, among other input devices configured to capture and/or receive data. Further, I/O interfaces 130 and 140 may include computer mouse, a keyboard, and/or a touch sensitive panel.

Communication interfaces 132 and 142 may take a variety of forms and may be configured to allow client devices 104 and 106 to communicate with one or more devices according to any number of protocols. For instance, communication interfaces 132 and 142 may be configured to allow client devices 104 and 106, respectively, to communicate with the traffic control device 102 via the communication network/interface 108. As noted, the communication interface 112 may take the form of a wireless interface and/or a wired interface to facilitate the communication with client devices 104 and/or 106.

Processors 134 and 144 may include general purpose processors and/or special purpose processors. Data storages 136 and 146 may include one or more volatile, non-volatile, removable, and/or non-removable storage components, and may be integrated in whole or in part with processors 134 and 144, respectively. Further, data storages 136 and 146 may take the form of non-transitory computer-readable storage mediums, having stored thereon machine-readable instructions that, when executed by processors 134 and 144, cause client devices 104 and 106 to perform operations, respectively, such as those described in this disclosure and illustrated by the accompanying figures. Such machine-readable instructions may define or be part of a discrete software application, such a native app or web app that can be executed upon user request, for instance.

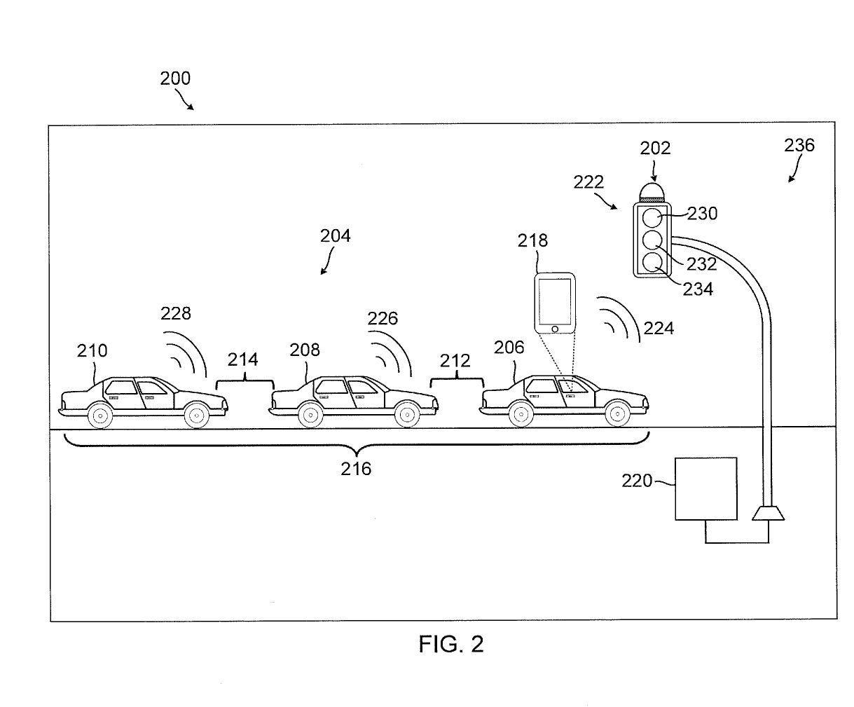

FIG. 2 illustrates an exemplary traffic control system 200, according to an embodiment. The traffic control system 200 may, for example, take the form of the traffic control system 100 described above in relation to FIG. 1. Further, the traffic control device 202 may, for example, take the form of the traffic control device 102. Yet further, client device 218 may, for example, take the form of one or more of client devices 104 and/or 106. In addition, the traffic controller 220 may, for example, take the form of one or more of client devices 104 and/or 106.

In some embodiments, the traffic control system 200 may include one or more vehicles. As shown, the one or more vehicles may include a vehicle 206, a vehicle 208, a vehicle 210, and/or other vehicles. The vehicles 206-210 may include mobile vehicles, automobiles, cars, sedans, sport utility vehicles (SUVs), trucks, semi-trucks, buses, motorhomes, motorcycles, and/or other vehicles configured to travel on roads and/or highways. In some embodiments, the vehicles 206-210 may include mobile structures that may travel proximate to the roads and/or highways. For example, the vehicles 206-210 may include watercrafts, vessels, aircrafts, and/or other mobile structures configured to traverse through land, water, and/or air.

In some embodiments, a communication interface of the traffic control device 202 may receive one or more signals 224, 226, and/or 228 indicating one or more of vehicles 206, 208, and/or 210 proximate to a location 236. The communication interface of the traffic control device 202 may take the form of the communication interface 112 described above in relation to FIG. 1. Further, the signals 224-228 may, for example, take the form of the signals, data signals, and/or data described above. The location 236 may include one or more locations of a traffic light 222, a traffic controller 220, a highway, a road, and/or other objects associated with a given location. Further, the communication interface may receive the signals 224-228 from the vehicles 206-210. For example, the communication interface may receive the signal 224 from the vehicle 206, the signal 226 from the vehicle 208, and/or the signal 228 from the vehicle 210. In some instances, the communication interface may receive the signal 224 from the client device 218 that may, for example, take the form of one or more of the client devices 104 and/or 106. As shown, the client device 218 may take the form of a portable device such as a cell phone in the vehicle 206. As such, the communication interface of the traffic control device 202 may receive the signal 224 from the client device 218 in the vehicle 206.

In some embodiments, a signal processing component of the traffic control device 202 may determine a convoy 204 based at least on one or more of the signals 224, 226, and/or 228, where the convoy 204 includes one or more of the vehicles 206, 208, and/or 210 proximate to the location 236. The signal processing component of the traffic control device 202 may, for example, take the form of the signal processing component 118 and/or the processor 120 described above in relation to FIG. 1. In some instances, the signal processing component may determine the convoy 204 based on one or more of the signals 224, 226, and/or 228 indicating, identifying, and/or specifying one or more of the vehicles 206, 208, and/or 210 in the convoy 204. In some embodiments, one or more of the signals 224, 226, and/or 228 may include a signal from the portable device 218 in the first vehicle 206 of one or more of the vehicles 206-208. Further, the signal 224 may indicate the location 236 proximate to one or more of the vehicles 206, 208, and/or 210. For example, signals 224, 226, and/or 228 may include GPS signals, GPS data, and/or other types of data indicating the location 236 of one or more of the vehicles 206, 208, and/or 210, respectively.

In some embodiments, the signals 224, 226, and/or 228 may include Doppler signals, radio detection and ranging (RADAR) signals, laser detection and ranging (LIDAR) signals, camera signals, range finder signals, and/or other types of signals indicating location 236 of one or more of the vehicles 206, 208, and/or 210. For example, one or more of the signals 224, 226, and/or 228 may include reflection signals. In particular, the traffic control device 202 may produce and/or generate signals that reflect from one or more of vehicles 206, 208, and 210, and return to the traffic control device 202. In some embodiments, signals 224, 226, and/or 228 may be data signals that provide data indicative of the one or more of the vehicles 206, 208, and/or 210, respectively, such as vehicle identification numbers (VIN), license plate numbers, driver license numbers of drivers, and/or other types of numbers and/or codes that identify one or more of the vehicles 206, 208, and/or 210.

In some embodiments, a data processing component of the traffic control device 202 may determine traffic-signal data based at least on the convoy 204. The data processing component may, for example, take the form of the processor 120 and/or the signal processing component 118 described above in relation to FIG. 1. In some instances, the traffic-signal data may cause the traffic controller 220 and/or the traffic light 222 to provide one or more traffic signals. Further, the traffic-signal data may be configured to maintain one or more threshold distances 212 and/or 214 between the vehicles 206, 208, and/or 210 in the convoy 204. For example, the traffic-signal data may be configured to maintain a threshold distance 216 between the vehicles 206 and 208. In some instances, the threshold distances 212, 214, and/or 216 may be include inches, feet, meters, kilometers, miles, and/or other measurable distances between vehicles. Yet further, the threshold distances 212, 214, and/or 216 may be distances based on speed, headings, directions, and/or other movements of one or more of the vehicles 206, 208, and/or 210. In addition, the threshold distances 212, 214, and/or 216 may be based on one or more speed limits, time periods it may take for vehicle 208 to collide into vehicle 206, time periods it may take for vehicle 210 to collide into vehicle 208, weather conditions that may affect the vehicles 206-208, and/or other variables related to one or more of the vehicles 206, 208, and/or 210. Further, the threshold distances 212, 214, and/or 216 may be distances based on one or more regulations, traffic regulations, rules of a traffic agency or an administration, e.g., national highway traffic and safety administration (NTSA), and/or other traffic and vehicle safety organizations.

In some embodiments, the traffic controller 202 may transmit the traffic-signal data to the traffic controller 220. For example, a transceiver in the communication interface may transmit the traffic-signal data to the traffic controller 220. The transceiver of the communication interface may, for example, take the form of the transceiver 114 of the communication interface 112 described above in relation to FIG. 1. In some instances, the traffic controller 220 may be configured to select one or more of traffic signals 230, 232, and/or 234. For example, the traffic signal 230 may be a stop signal, e.g. a red signal, the traffic signal 232 may be a warning/yield signal, e.g., a yellow signal, and/or the traffic signal 234 may be a proceed signal, e.g., a green signal. Further, one or more of the traffic signals 230, 232, and/or 234 may enable one or more of the vehicles 206, 208, and/or 210 to maintain the threshold distance 212, 214, and/or 216 between the vehicles 206, 208, and/or 210 in the convoy 204.

In some embodiments, the traffic-signal data may cause the traffic controller 220 and/or the traffic light 202 to select a traffic signal from one or more of the traffic signals 230-234. Further, the selected traffic signal may enable one or more of the vehicles 206, 208, and/or 210 to maintain one or more of the threshold distances 212, 214, and/or 216 between the vehicles 206, 208, and/or 210 in the convoy 204. In some instances, the selected traffic signal may be the traffic signal 230, e.g., a stop signal, causing the vehicles 206, 208, and 210 to stop before the traffic light 222.

In some embodiments, the traffic-signal data may cause the traffic controller 220 and/or the traffic light 202 to select a warning signal from one or more of the traffic signals 230-234. Further, the warning signal, e.g., the signal 232, may indicate a change in one or more of the traffic signals 230-234. For example, the signal 232 may indicate a change from the traffic signal 234 to the traffic signal 230, possibly causing the vehicles 206-210 to slow down and/or stop before the traffic light 222. As such, the warning signal 232 may enable one or more of the vehicles 206, 208, and/or 210 to maintain one or more of the threshold distances 212, 214, and/or 216 between the vehicles 206, 208, and/or 210 in the convoy 204.

In some embodiments, the traffic-signal data may cause the traffic controller 220 to select a proceed signal from one or more of the traffic signals 230-234. Further, the proceed signal, e.g., the signal 234, may indicate and/or inform one or more of the vehicles 206, 208, and/or 210 to proceed for a time period. For example, the signal 234 may cause one or more of the vehicles 206, 208, and/or 210 to maintain respective speeds through the traffic light 222. Further, the signal 234 may cause one or more of the vehicles 206, 208, and/or 210 to change respective speeds, e.g. increase respective speeds, through the traffic light 222. Yet further, the signal 234 may cause one or more of the vehicles 206, 208, and/or 210 to maintain one or more of the threshold distances 212, 214, and/or 216 between the vehicles 206, 208, and/or 210 in the convoy 204. In addition, the traffic-signal data may cause the traffic controller 220 to extend the time period indicating and/or informing one or more of the vehicles 206, 208, and/or 210 to proceed. As such, the traffic-signal data may enable one or more of the vehicles 206, 208, and/or 210 to maintain one or more of the threshold distances 212 and/or 214 between the vehicles 206, 208, and/or 210 in the convoy 204.

It should be noted that the traffic-signal data may change, e.g., extend or shorten, various time periods associated with any one of the traffic signals 230-234. For example, the time period for signaling a proceed signal, e.g., the signal 234, may be extended, as described above. Further, the time period for signaling the signal 234 may be shortened to maintain vehicles 206-210 in the convoy 204. Yet further, the time period for signaling a warning signal, e.g., the signal 232, may be shortened to cause one or more of the vehicles 206, 208, and/or 210 to stay together in the convoy 204 and stopping before the traffic light 222. Yet further, the time period for signaling the stop signal 230 may be shortened when one or more vehicles 206, 208, and/or 210 are stopped at the stop signal 230 and separated from the convoy 204. For example, by shortening the time period for the signal 230, the one or more separated vehicles may catch up to the convoy 204 after the traffic light 222 turns to the signal 234.

In some embodiments, the data processing component may determine the traffic-signal data based at least on the signal 224 from the portable device 218. Further, the signal 224 may indicate the proximate location 236 of one or more of the vehicles 206, 208, and/or 210. Further, the signal 224 may indicate a number, e.g., a total number, of one or more of the vehicles 206, 208, and/or 210 in the convoy 204, possibly indicating three vehicles as shown in FIG. 2. Yet further, the signal 224 may indicate a speed of one or more of the vehicles 206, 208, and/or 210. In addition, the signal 224 may include an indication of one or more other vehicles proximate to the convoy 204. For example, the one or more other vehicles may be behind the convoy 204, adjacent to the convoy 204, and/or ahead of the convoy 204.

As noted, the traffic control system 200 and/or the traffic control device 202 may determine a number, e.g., a total number, of one or more of the vehicles 206, 208, and/or 210 in the convoy 204. Further, the traffic control system 200 and/or the traffic control device 202 may determine the number meets a threshold number of vehicles for the convoy 204. Yet further, the traffic control system 200 and/or the traffic control device 202 may initiate a removal of at least one vehicle from the convoy 204. For example, the traffic control system 200 may initiate a removal of the vehicle 210 from the convoy 204. In addition, the data processing component may determine the traffic-signal data based at least on the removal of at least one vehicle. As such, the transceiver may transmit the traffic-signal data to the traffic controller 220 to maintain the threshold distance 212 between the vehicles 206 and 208 in the convoy 204.

In some embodiments, the traffic control system 200 and/or the traffic control device 202 may determine the number of the one or more vehicles 206, 208, and/or 210 in the convoy 204 is below a threshold number of vehicles for the convoy 204. Further, the traffic control system 200 and/or the traffic control device 202 may initiate an addition of at least one vehicle to the convoy 204. Yet further, the data processing component may determine the traffic-signal data based at least on the addition of the one vehicle. As such, the transceiver may transmit the traffic-signal data to the traffic controller 220 to include the additional vehicle with one or more of the vehicles 206, 208, and/or 210 in the convoy 204.

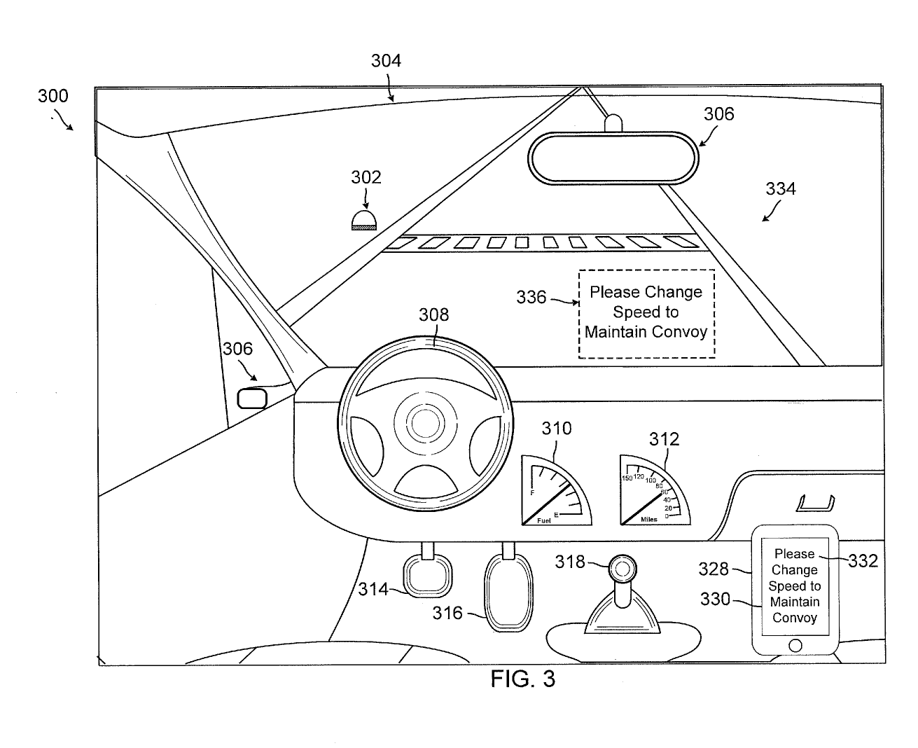

FIG. 3 illustrates a traffic control device 302, according to an embodiment. As shown, a vehicle 300 may take the form of the vehicle 206 described above in relation to FIG. 2. As shown, the vehicle 300 may include a windshield and/or windshield display 304 possibly including sensors configured to detect rain, snow, wind, and/or other weather conditions that may affect driving the vehicle 300. Further, the vehicle 300 may include one or more mirrors 306, a steering wheel/actuator 308, a fuel gauge 310, a speedometer 312, a brake 314, an accelerator 316, a shifter/controller 318, and/or other parts of a vehicle. Further, the vehicle 300 may include a client device 328 that may, for example, take the form of the client device 218 described above in relation to FIG. 2.

In some embodiments, the traffic control device 302 may include a communication interface that may, for example, take the form of the communication interfaces described above in relation to FIGS. 1-2. Further, the traffic control device 302 may include one or more processing components that may, for example, take the form of the signal processing components and/or the processors described above in relation to FIGS. 1-2. Yet further, the traffic control device 302 may include a non-transitory computer-readable medium having stored thereon machine-readable instructions that, when executed by the one or more processing components, cause performance of operations.

In some embodiments, various operations of the traffic control device 302 may include receiving, by the communication interface, one or more signals from at least one vehicle, e.g., the vehicle 300. In some instances, the one or more signals may take the form of the signals 224, 226, and/or 228 described above in relation to FIG. 2 and/or other signals described above. Further, in some embodiments, the operations may include determining, by the one or more processing components, a presence of convoy. In some instances, the presence of the convoy may be determined based at least on the one or more signals. Yet further, the convoy may include one or more vehicles, including the vehicle 300.

In some embodiments, various operations of the traffic control device 302 may include determining, by one or more of the processing components, a length of the convoy. For example, the traffic control device 302 may determine the length of the convoy based on the one or more signals received from the vehicle 300. In some instances, the one or more signals may include data signals and/or data indicating the length of the convoy. Further, the one or more signals may indicate the number of vehicles in the convoy and/or a distance between a first vehicle in the convoy and a last vehicle in the convoy. For example, referring back to FIG. 2, the traffic control device 302 take the form of the traffic control device 202. As such, the traffic control device 302 may determine the length of the convoy 204 based on the number of the vehicles 206, 208, and/or 210 in the convoy 200. In some instances, the traffic control device 302 may determine the length of the convoy based on a distance, e.g., a distance 216, between the first vehicle 206 and the last vehicle 210 in the convoy 204.

In some embodiments, various operations of the traffic control device 302 may include determining a rate of travel for the convoy. For example, the traffic control device 302 may determine one or more speeds, velocities, relative velocities, directions, headings, and/or other movements of the convoy. In some instances, the traffic control device 302 may determine the rate of travel based on one or more signals described above. In addition, the traffic control device 302 may send and/or receive RADAR signals, LIDAR signals, and/or other motion-detecting signals to determine the rate of travel. In some instances, the traffic control device 302 may determine the rate of travel of one or more vehicles in the convoy, including the vehicle 300. In some instances, the traffic control device 302 may request and/or receive the rate of travel from the vehicle 300, where the rate is measured by the speedometer 312. Yet further, the traffic control device 302 may receive the rate of travel from various client devices, e.g., client device 328 and/or other client devices in the passing vehicles proximate to the vehicle 300. In some instances, the traffic control device 302 may calculate the rate of travel. For example, the traffic control device 302 may determine one or more locations, headings, and/or directions of the convoy over various periods of time to calculate the rate of travel.

In some embodiments, the traffic control device 302 may receive other signals from the vehicle 300. For example, the vehicle 300 may detect rain, snow, wind, and/or other weather conditions based on one or more sensors, e.g., rain sensors, in the windshield 304. As such, the traffic control device 302 may receive signals from the vehicle 300 indicative of the weather conditions. Further, the one or more processing components of the traffic control device 302 may determine a convoy based on the detected weather conditions. Further, creating the convoy may reduce the probability of an accident related to the weather conditions and one or more of the vehicles in the convoy.

In some embodiments, various operations of the traffic control device 302 may include determining, by one or more of the processing components, data based on at least one of the length of the convoy and the rate of travel of the convoy. The data may include traffic-signal data configured to cause a traffic controller to select one or more traffic signals in any manner described above in relation to FIG. 2. Further, the data may include instruction data indicative of an instruction for at least one of the two or more vehicles. In some instances, the instruction data may be rendered on a display 330 of the client device 328. Further, the instruction data may be rendered on the windshield display 304 of the vehicle 300. In some instances, the instruction data may be configured to maintain a threshold distance between a first vehicle, e.g., the vehicle 300, and a last vehicle of the one or more vehicles in the convoy. For example, referring back to FIG. 2, the data may be configured to maintain the threshold distance 216 between the first vehicle 206 and the last vehicle 210 of one or more of the vehicles 206, 208, and/or 210 in the convoy 204. In some embodiments, the operations may include transmitting, by a transceiver of the communication interface, the data to the two or more vehicles. For example, the transmitter may take the form of the transceiver 114 and/or other transceivers described above in relation to FIGS. 1-2.

As noted, various operations of the traffic control device 302 may include determining the data based on at least one of the length of the convoy and the rate of travel of the convoy, where the data may include instruction data indicative of an instruction. For example, the instruction(s), e.g., instruction 332 and/or 336, may be for the first vehicle 300 of the convoy to decrease its speed. Yet further, the instructions 332 and/or 336 may cause the first vehicle 300 to maintain a threshold distance between the first vehicle 300 and the last vehicle in the convoy. As noted, the operations may include transmitting the data to the one or more vehicles of the convoy, e.g., the vehicle 300. Further, the operations may include transmitting the instructions 332 and/or 336 to the first vehicle 300. For example, the instruction 332 may be rendered on the display 330 of the client device 328. Further, the instruction 336 may be rendered on the windshield display 304 of the vehicle 300. As shown, the instructions 332 and/or 336 may include the words, “Please Change Speed to Maintain Convoy.” Further, the instructions 332 and/or 336 may include one or more target speeds in the instructions 332 and/or 336, indicating one or more target speeds for vehicle 300 to maintain the convoy.

As noted, the operations may include one or more of the processing components determining data based on at least one of the length of the convoy and the rate of travel of the convoy, where the data may include instruction data indicative of an instruction. For example, the instruction may be for the last vehicle of the convoy to increase its speed. For example, the instruction may provide and/or sound words such as, “Please Increase Your Speed”, via an audio speaker. Yet further, the words may be displayed in a windshield display and/or a display of a portable device in the last vehicle. In some instances, the instruction may cause the last vehicle to maintain the threshold distance between the first vehicle and the last vehicle. As such, the operations may include transmitting the instruction to the last vehicle of the convoy.

In some embodiments, various operations of the traffic control device 302 may include determining, by the one or more processing components, a number of one or more of the vehicles. For example, the number may be a total number of the vehicles that meets a threshold number of vehicles for the convoy. In some instances, the total number of the vehicles may exceed the threshold number such that the traffic control device 302 provides instructions to the vehicles to split the convoy into two or more separate convoys. In some instances, splitting the convoy into separate convoys may be more efficient and/or safer for the vehicles to reach a particular destination. As noted, the operations may include one or more processing components determining data based on at least one of the length of the convoy and the rate of travel of the convoy, where the data may include instruction data indicative of an instruction. In some instances, the instruction may be for a vehicle of the one or more vehicles in the convoy to exit the convoy. Further, the operations may include transmitting the instruction to the vehicle to exit the convoy.

In some embodiments, various operations of the traffic control device 302 may include determining, by the one or more processing components, traffic-signal data based at least on the convoy. Referring back to FIG. 2, the traffic-signal data may be configured to maintain the threshold distance 216 between the first vehicle 206 and the last vehicle 210 of one or more of the vehicles 206, 208, and/or 210 in the convoy 204. Further, the traffic-signal data may be configured to cause the traffic controller 220 to select at least one of the stop signal 230, the warning signal 232, and/or the proceed signal 234 in any manner described above. Further, the operations may include the communication interface of the traffic control device 202 transmitting the traffic-signal data to the traffic controller 220. Yet further, the one or more selected traffic signals 230, 232, and/or 234 may enable one or more of the vehicles 206, 208, and/or 210 to maintain the threshold distance 216 between the first vehicle 206 and the last vehicle 210.

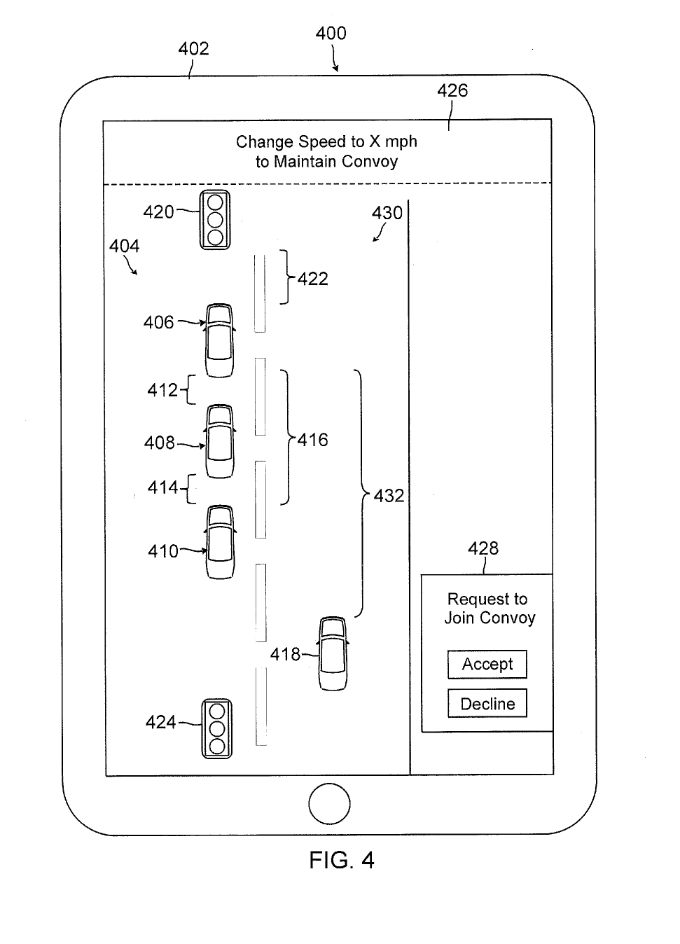

FIG. 4 illustrates a client device 400, according to an embodiment. In some embodiments, the client device 400 may, for example, take the form of client devices 218, 328, and/or other devices described above in relation to FIGS. 1-3. As shown, the client device 400 may be located in a first vehicle 406. As shown, the client device 400 includes a display 402 that may provide and/or render data received from one or more of the traffic control devices 102, 202, and/or 302 described above in relation to FIGS. 1-3. Further, the display 402 may provide a convoy 404 of vehicles 406, 408, and/or 410 that may, for example, take the form of the convoy 204 of the vehicles 206, 208, and/or 210, respectively, among other convoys described above in relation to FIGS. 1-3. Yet further, distances 412, 414, and/or 416 may, for example, take the form of distances 212, 214, and/or 216, among other distances described above in relation to FIGS. 1-3. As shown, a distance 422 may provide a distance between the vehicle 406 and a traffic light 420 that may take the form of the traffic light 222 described above in relation to FIG. 2. Yet, further other distances may also be provided, possibly related to another traffic light 424 that may, for example, take the form of the traffic light 420.

In some embodiments, various operations may be implemented by the traffic control devices described above in relation to FIG. 1-3. For example, the operations may include determining data based at least on the convoy 404. Further, the operations may include determining instruction data indicative of an instruction 426 for the first vehicle 406 to change its speed. Yet further, the instruction 426 may cause the first vehicle 406 to maintain the threshold distance 416 between the first vehicle 426 and the last vehicle 410 in the convoy 404. As noted, the operations may include transmitting the data to one or more vehicles, e.g., the first vehicle 406. Further, the operations may include transmitting the instruction 426 to the first vehicle 406. For example, the instruction 426 may be rendered on the display 402 of the client device 400. As shown, the instruction 426 may include the words, “Please Change Speed to X mph to Maintain Convoy.” For example, the words may include one or more target speeds in miles per hour to maintain the convoy 404. In some embodiments, these words may be provided through an audio speaker of the client device 400.

As noted, various operations of a traffic control device may include determining data based at least on the convoy. The data may, for example, be rendered on the display 402 of the client device 400. Further, referring back to FIG. 3, the data may be rendered on the windshield display 304 of the vehicle 300. In some instances, the data may be configured to maintain threshold distances between one or more of the vehicles 406, 408, and/or 410 in the convoy 404. For example, the data may be configured to maintain the threshold distance 416 between the first vehicle 406 and the last vehicle 410 of one or more of the vehicles 406, 408, and/or 410 in the convoy 404. In some embodiments, the operations may include transmitting the data to one or more of the vehicles 406, 408, and/or 410 such as the first vehicle 406, for example.

In some embodiments, various operations of the traffic control device may include receiving a request 428 from the vehicle 418 to join the convoy 404. Further, the operations may include determining, by the one or more processing components, a second convoy 430 based at least on the request 428 from the joining vehicle 418. Yet further, determining the second convoy 430 may include the joining vehicle 418 and one or more of the vehicles 406, 408, and/or 410. In addition, the operations may include determining, by the one or more processing components, second data based at least on the second convoy 430. Further, the second data may be configured to maintain a second threshold distance 432 between the first vehicle 406 and the joining vehicle 418. Yet further, the operations may include transmitting the second data to the one or more vehicles such as the vehicle 406 and/or the client device 402. As shown, the request 428 may include an “accept” and a “decline” input that may be selectable via touch inputs. By accepting the request 428, the joining vehicle 418 may be provided with instructions to change lanes and position the vehicle 418 behind the vehicle 410.

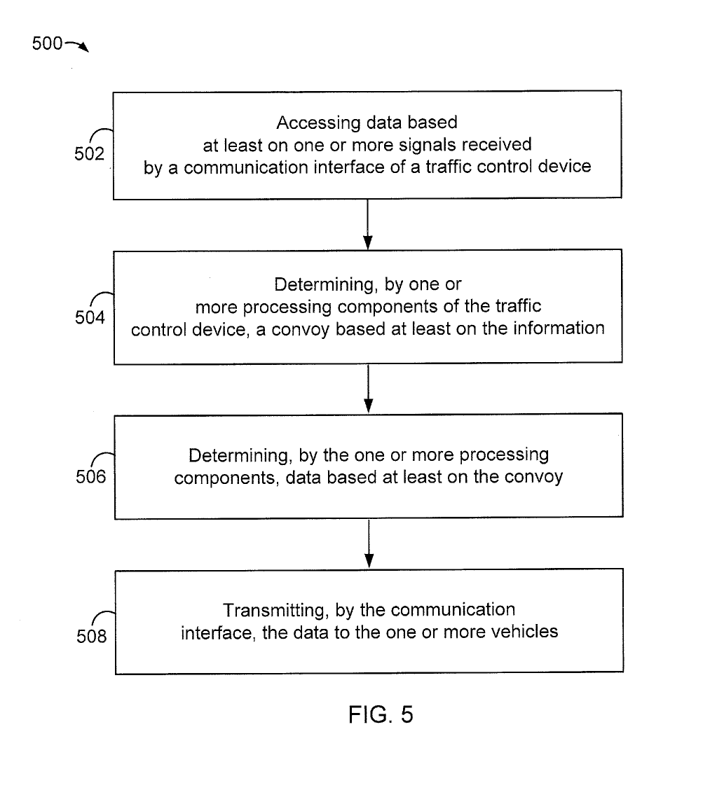

FIG. 5 is a flowchart of an exemplary method 500, according to an embodiment. Note that one or more steps, processes, and methods described herein may be omitted, performed in a different sequence, and/or combined for various types of applications.

At step 502, the method 500 may include accessing data based at least on one or more signals received by a communication interface of a traffic control device. For example, the one or more signals may be received from one or more of the vehicles in any manner described above in relation to FIGS. 1-4. Referring back to FIG. 1, the signals, data signals, and/or data may be stored in the data storage 116 and/or other data storages described above. In such instances, the traffic control device 102 may access the data from the data storage 116.

At step 504, the method 500 may include determining, by one or more processing components of the traffic control device, a convoy based at least on the information, where the convoy includes the one or more vehicles. In some instances, the convoy may be determined in any manner described above in relation to FIGS. 1-4. For example, a traffic control system and/or a traffic control device may determine a convoy to maintain traffic flows in a city or town. Yet further, the traffic control system and/or the traffic control device may determine a convoy based on a request from a driver to create the convoy.

At step 506, the method 500 may include determining, by the one or more processing components, data based at least on the convoy. In some instances, the data may be determined in any manner described above in relation to FIGS. 1-4. Further, the data may be determined to maintain the one or more vehicles in the convoy. In some instances, the data may be determined to include traffic-signal data and/or data configured to maintain a threshold distance between one or more of the vehicles in the convoy described above in relation to FIGS. 1-4.

At step 508, the method 500 may include transmitting, by a transceiver of the communication interface, the data to the one or more vehicles. In some instances, the transceiver may transmit the data in any manner described above in relation to FIGS. 1-4.

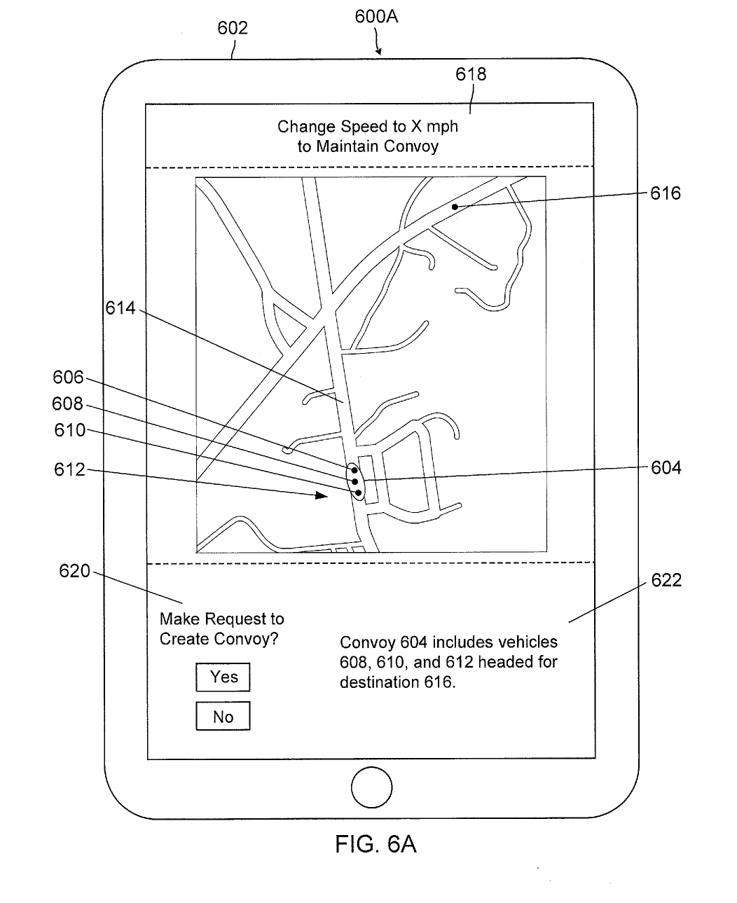

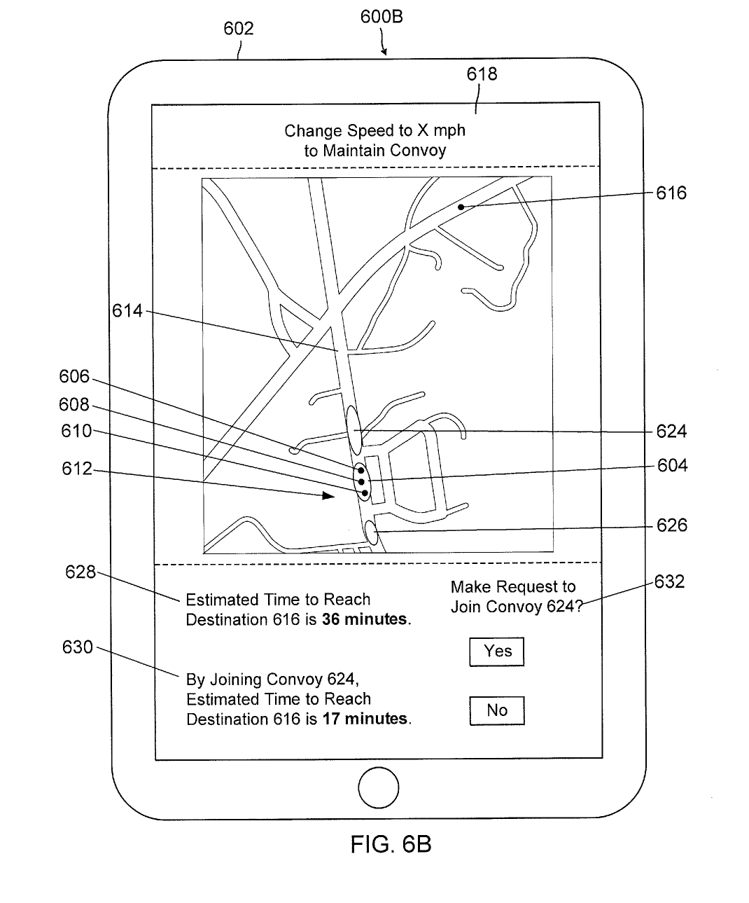

FIG. 6A illustrates a client device 600A, according to an embodiment. In some embodiments, the client device 600A may, for example, take the form of client devices 218, 328, 400, and/or other devices described above in relation to FIGS. 1-5. As shown, the client device 600A includes a display 602 that may provide data received from one or more of the traffic control devices 102, 202, and/or 302, among other traffic control devices described above in relation to FIGS. 1-5. For example the client device 600A may receive geographic and/or location data, e.g., a map, from the traffic control devices and render the data on the display 602. Further, the display 602 may render data of vehicles 606, 608, and/or 610 that may, for example, take the form of the vehicles 406, 408, and/or 410, respectively, among other vehicles described above in relation to FIGS. 1-5. In some instances, the client device 600A may be located in the first vehicle 606, among the other vehicles 608 and/or 610.

In some embodiments, the client device 600A may send one or more signals to a traffic control device. In some instances, the one or more signals may indicate a request 620 to create a convoy 604 for the one or more vehicles 606, 608, and/or 610. As shown, the request 620 may include a “yes” and a “no” input that may be selectable via touch inputs. For example, by selecting “yes”, the client device 600A may send a request to the traffic control device to create a convoy 604 for leaving the origin 612 and reaching the destination 616.

Further, the request 620 to create the convoy may indicate an identification 622 of each of one or more of the vehicles 606, 608, and/or 610 and the destination 616 for the convoy 604. Further, the traffic control device may receive the one or more signals and store data based on the one or more signals received. As noted, a traffic control method, e.g., the method 500, may include the traffic control device accessing data, e.g., the stored data, based on the one or more signals received. Further, the traffic control device may determine the convoy 604 based at least on analyzing the request 620 to create the convoy 604 and granting the request 620 to create the convoy 604.

In some instances, a traffic control method, e.g., the method 500, may include determining, by one or more processing components of a traffic control device, a location for each of the vehicles 606, 608, and/or 610. Yet further, the method may include determining, by the one or more processing components, instructions 618 for each of the one or more vehicles 606, 608, and/or 610. In some instances, the instructions 618 may be configured to maintain the one or more vehicles in the convoy 604. As shown, the instruction 618 may include the words, “Please Change Speed to X mph to Maintain Convoy.” Yet further, the instruction 618 may cause the first vehicle 606 to decrease its speed to maintain a threshold distance between the first vehicle 606 and the last vehicle 610 in the convoy 604. The threshold distance may, for example, take the form of one or more of the threshold distances 412, 414, 416, and/or other threshold distances described above in relation to FIGS. 1-5. In addition, the method may include transmitting, by the communication interface of the traffic control device, the instructions 618 to each of one or more of the vehicles, e.g., the vehicle 606, to maintain one or more of the vehicles 606, 608, and/or 610 in the convoy 604.

As noted, a traffic control method, e.g., the method 500, may include determining a convoy. For example, the convoy 604 may be determined based on a location of one or more of the vehicles 606, 608, and/or 610. Further, the convoy 604 may be determined based on a direction and/or heading of one or more of the vehicles 606, 608, and/or 610. Yet further, the convoy 604 may be determined based on a speed of one or more of the vehicles 606, 608, and/or 610. In addition, the convoy 604 may be determined based on the origin 612 of one or more of the vehicles 606, 608, and/or 610, and/or the destination 616 of one or more of the vehicles 606, 608, and/or 610.

In some embodiments, the traffic control device may determine second data. For example, a traffic control method, e.g., the method 500, may include determining second data based at least on the convoy 604, where the second data is configured to maintain one or more of the vehicles 606, 608, and/or 610 in the convoy 604. Further, the method may include transmitting, by the communication interface of the traffic control device, the second data to a traffic controller configured to select one or more traffic signals. Yet further, the one or more selected traffic signals may maintain one or more of the vehicles 606, 608, and/or 610 in the convoy 604. The second data may, for example, cause the traffic controller to select the one or more traffic signals in any manner described above in relation to FIG. 2.

FIG. 6B illustrates a client device 600B, according to an embodiment. In some embodiments, the client device 600B may, for example, take the form of the client devices 600A and/or other devices described above in relation to FIGS. 1-6A. As shown, the client device 600B includes the display 602 that may render data received from one or more of the traffic control devices 102, 202, and/or 302, among other traffic control devices described above in relation to FIGS. 1-6A. For example, the display 602 may render geographic and/or location data, e.g., a map. Further, the display 602 may render data of the vehicles 606, 608, and/or 610 described above in relation to FIG. 6A. Further, the display 602 may render the origin 612, the path 614, and the destination 616 of the convoy 604. It should be noted that the client device 600B may be located in the first vehicle 606 or the other vehicles 608 and/or 610.

As shown, the display 602 may also render a second convoy 624 ahead of convoy 604 and/or a third convoy 626 behind the convoy 604. In some instances, the convoys 624 and/or 626 may also be headed toward the destination 616 along the path 614. As shown, the third convoy 626 may be located behind the convoy 604 and/or the origin 612 such that the third convoy 626 may be headed toward the convoy 604.

In some embodiments, a traffic control method, e.g., the method 500, may include determining the second convoy 624 proximately located to the convoy 604. Further, the method may include determining second data based at least on the second convoy 624, where the second data is indicative of a request 632 for the convoy 604 to join the second convoy 624. In some instances, the request 632 may be a request by one or more of the vehicles 606, 608, and/or 610 of the convoy 604 to join the second convoy 624, possibly changing from the convoy 604 to the second convoy 624. Further, the request 632 may be a request to join or combine the convoy 604 with the second convoy 624.

As shown, information 628 may provide the estimated time, e.g., 36 minutes, it may take for the convoy 604 to reach the destination 616. Yet further, information 630 may provide the estimated time, e.g., 17 minutes, it may take for the second convoy 624 to reach the destination 616. In some instances, it may take the second convoy 624 less time to reach the destination 616 than the convoy 604, possibly due to differences between the number of vehicles in the convoys 604 and 624. For example, there may be more vehicles in the second convoy 624 such that one or more traffic control devices control traffic lights may allow vehicles in the second convoy 624 to pass through additional intersections without stopping or slowing down.

In some embodiments, the traffic control method may include transmitting the request 632 to one or more vehicles 606, 608, and/or 610. For example, the request 632 may be rendered on the display 602 of the client device 600B located in the vehicle 606. As shown, the request 632 may include a “yes” input and a “no” input that may be selectable via touch inputs. For example, by selecting “yes”, one or more of the vehicles 606, 608, and/or 610 may request to be joined with convoy 624.

In some embodiments, a traffic control system may include a communication interface of a traffic control device with means for receiving one or more signals indicating one or more vehicles proximate to a location. Further, the traffic control system may include a signal processing component of the traffic control device with means for determining a convoy based at least on the one or more signals, where the convoy includes the one or more vehicles proximate to the location. Yet further, the traffic control system may include a data processing component of the traffic control device with means for determining traffic-signal data based at least on the convoy, where the traffic-signal data is configured to maintain a threshold distance proximate to the one or more vehicles in the convoy. In addition, the traffic control system may include a transceiver of the communication interface with means for transmitting the traffic-signal data to a traffic controller configured to select one or more traffic signals, where the one or more traffic signals enable the one or more vehicles to maintain the threshold distance proximate to the one or more vehicles in the convoy.

The above details description describes various features and functions of the disclosed systems, devices, mediums, and/or methods with reference to the accompanying figures. It should be readily understood that the aspects of the present disclosure, as generally described herein, and illustrated in the figures, can be arranged, substituted, combined, separated, and designed in a wide variety of different configurations, all of which may be contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium such as a storage device including a disk or hard drive or other storage media.

The computer-readable medium may also include non-transitory computer-readable media such as media that stores data for short periods of time like register memory, processor cache, and/or random access memory (RAM). The computer-readable medium may also include non-transitory computer-readable media such as media that may store program code and/or data for longer periods of time, such as secondary or persistent long term storage, like read-only memory (ROM), optical or magnetic disks, and/or compact-disc read only memory (CD-ROM), for example. Thus, various forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read. Moreover, a step or block that represents one or more information transmissions may correspond to information transmissions between software and/or hardware modules in the same physical device. Further, other information transmissions may be between software modules and/or hardware modules in different physical devices.

In various embodiments of the present disclosure, execution of instruction sequences to practice the present disclosure may be performed by a computer system. In various other embodiments of the present disclosure, a plurality of computer systems coupled by a communication link to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure and the accompanying figures may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The present disclosure, the accompanying figures, and the claims are not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A traffic control system, comprising:
a communication interface of a traffic control device that receives one or more signals indicating two or more vehicles proximate to a location;
a signal processing component of the traffic control device that determines a convoy based at least on the one or more signals, wherein the convoy comprises the two or more vehicles proximate to the location;
a data processing component of the traffic control device that determines traffic-signal data based at least on the convoy, wherein the traffic-signal data is configured to maintain a threshold distance between the two or more vehicles in the convoy; and
a transceiver of the communication interface that transmits the traffic-signal data to a traffic controller configured to select one or more traffic signals, wherein the one or more traffic signals enable the two or more vehicles to maintain the threshold distance between the two or more vehicles in the convoy.

2. The traffic control system of claim 1, wherein the traffic-signal data causes the traffic controller to select a traffic signal from the one or more traffic signals, and wherein the selected traffic signal enables the two or more vehicles to maintain the threshold distance between the two or more vehicles in the convoy.

3. The traffic control system of claim 1, wherein the traffic-signal data causes the traffic controller to select a warning signal from the one or more traffic signals, wherein the warning signal indicates a change in the one or more traffic signals, and wherein the warning signal enables the two or more vehicles to maintain the threshold distance between the two or more vehicles in the convoy.

4. The traffic control system of claim 1, wherein the traffic-signal data causes the traffic controller to select a proceed signal from the one or more traffic signals, wherein the proceed signal indicates the two or more vehicles to proceed for a time period, and wherein the traffic-signal data further causes the traffic controller to extend the time period to enable the two or more vehicles to maintain the threshold distance between the two or more vehicles in the convoy.

5. The traffic control system of claim 1, wherein the one or more signals comprise a signal from a portable device in a first vehicle of the two or more vehicles, and wherein the signal indicates the location proximate to the two or more vehicles.

6. The traffic control system of claim 5, wherein the data processing component further determines the traffic-signal data based at least on the signal from the portable device, and wherein the signal further indicates at least one of the following: the proximate location of the two or more vehicles, a number of the two or more vehicles in the convoy, a speed of the two or more vehicles, and an indication of one or more other vehicles proximate to the convoy.

7. The traffic control system of claim 1, wherein the traffic control system further determines a number of the two or more vehicles in the convoy meets a threshold number of vehicles for the convoy, wherein the traffic control system initiates a removal of at least one vehicle from the convoy, and wherein the data processing component further determines the traffic-signal data based at least on the removal of the at least one vehicle.

8. The traffic control system of claim 1, wherein the traffic control system further determines a number of the two or more vehicles in the convoy is below a threshold number of vehicles for the convoy, and wherein the traffic control system initiates an addition of at least one vehicle to the convoy, and wherein the data processing component further determines the traffic-signal data based at least on the addition of the at least one vehicle.

9. A traffic control device comprising:
one or more processing components; and
a non-transitory computer-readable medium having stored thereon machine-readable instructions that, when executed by the one or more processing components, cause performance of operations comprising:
determining, by the one or more processing components, a presence of a convoy, wherein the convoy comprises two or more vehicles;
determining, by the one or more processing components, a length of the convoy;
determining, by the one or more processing components, a rate of travel for the convoy; and
determining, by the one or more processing components, data based on at least one of the length and the rate of travel, wherein the data comprises at least one of traffic-signal data configured to cause a traffic controller to select one or more traffic signals and instruction data indicative of an instruction for at least one of the two or more vehicles.

10. The traffic control device of claim 9, wherein the instruction is for a first vehicle of the convoy to decrease its speed, wherein the instruction causes the first vehicle to maintain a threshold distance between the first vehicle and a last vehicle of the convoy, and wherein the operations comprising transmitting the instruction to the first vehicle.

11. The traffic control device of claim 9, wherein the instruction is for a last vehicle of the convoy to increase its speed, wherein the instruction causes the last vehicle to maintain a threshold distance between a first vehicle of the convoy and the last vehicle, and wherein the operations comprising transmitting the instruction to the last vehicle.

12. The traffic control device of claim 9, the operations further comprising:
determining, by the one or more processing components, a number of the one or more vehicles meets a threshold number of vehicles for the convoy, and wherein the instruction is for a vehicle of the one or more vehicles to exit the convoy, and wherein the operations comprise transmitting the instruction to the exiting vehicle to exit the convoy.

13. The traffic control device of claim 9, wherein the traffic-signal data is configured to cause the traffic controller to select at least one of a warning signal and a proceed signal, wherein the warning signal indicates a change in the one or more traffic signals, wherein the proceed signal indicates the one or more vehicles to proceed for a time period, wherein the operations further comprising:
transmitting, by a communication interface of the traffic control device, the traffic-signal data to the traffic controller, wherein the one or more selected traffic signals enable the one or more vehicles to maintain a threshold distance between a first vehicle of the convoy and a last vehicle of the convoy.

14. The traffic control device of claim 9, the operations further comprising:
receiving, by the communication interface, a request from a vehicle to join the convoy;
determining, by the one or more processing components, a second convoy based at least on the request from the joining vehicle, wherein the second convoy includes the joining vehicle and the one or more vehicles;
determining, by the one or more processing components, second data based at least on the second convoy, wherein the second data is configured to maintain a second threshold distance between the first vehicle and the joining vehicle; and
transmitting, by the transceiver, the second data to the one or more vehicles.

15. A traffic control method, comprising:
accessing data based at least on one or more signals received by a communication interface of a traffic control device, wherein the one or more signals are received from at least one vehicle of one or more vehicles;
determining, by one or more processing components of the traffic control device, a convoy based at least on the information, wherein the convoy comprises the one or more vehicles;
determining, by the one or more processing components, data based at least on the convoy, wherein the data is configured to maintain the one or more vehicles in the convoy; and
transmitting, by the communication interface, the data to the one or more vehicles.

16. The traffic control method of claim 15, wherein determining the convoy is based on at least one of the following: a location of the one or more vehicles, a direction of the one or more vehicles, a speed of the one or more vehicles, an origin of the one or more vehicles, and a destination of the one or more vehicles.

17. The traffic control method of claim 15, wherein the one or more signals indicate a request to create the convoy for the one or more vehicles, and wherein determining the convoy is based at least on analyzing the request to create the convoy and granting the request to create the convoy.

18. The traffic control method of claim 17, wherein the request to create the convoy indicates an identification of each of the one or more vehicles and a destination for the convoy, and wherein the method further comprises:
determining, by the one or more processing components, a location for each of the one or more vehicles;
determining, by the one or more processing components, instructions for each of the one or more vehicles, wherein the instructions are configured to maintain the one or more vehicles in the convoy; and
transmitting, by the communication interface, the instructions to each the one or more vehicles to maintain the one or more vehicles in the convoy.

19. The traffic control method of claim 15, further comprising:
determining second data based at least on the convoy, wherein the second data is configured to maintain the one or more vehicles in the convoy;
transmitting, by the communication interface, the second data to a traffic controller configured to select one or more traffic signals, wherein the one or more selected traffic signals maintain the one or more vehicles in the convoy.

20. The traffic control method of claim 15, further comprising:
determining a second convoy proximately located to the convoy;
determining second data based at least on the second convoy, wherein the second data is indicative of a request for the convoy to join the second convoy; and
transmitting the request to the one or more vehicles.
